(19) United States
(12) Patent Application Publication
(10) Pub. No.: US 2009/0148547 A1
(43) Pub. Date: Jun. 11, 2009

(54) DEVICE FOR PRODUCTION OF NANOFIBRES THROUGH ELECTROSTATIC SPINNING OF POLYMER SOLUTIONS

(75) Inventors: David Petras, Pertoltice (CZ); Ladislav Mares, Liberec (CZ); Jan Cmelik, Liberec (CZ); Karel Fiala, Dolni Pustevna (CZ)

Correspondence Address: OSTROLENK FABER GERB & SOFFEN, 1180 AVENUE OF THE AMERICAS, NEW YORK, NY, 100368403, US

(73) Assignee: ELMARCO S.R.O., LIBEREC EZECH (CZ)

(21) Appl. No.: 12/302,956

(22) PCT Filed: Jun. 1, 2007
(86) PCT No.: PCT/CZ07/00045

§ 371 Date: Dec. 1, 2008

(30) Foreign Application Priority Data
Jun. 1, 2006 (CZ) PV2006-359

(51) Int. Cl. B29C 47/10

(52) U.S. Cl. 425/174.8 E

(57) ABSTRACT

The invention relates to device for production of nanofibres through electrostatic spinning of polymer solutions comprising a spinning chamber, in which the reservoir of polymer solution is positioned, into which by a section of its circumference extends the rotating spinning electrode of elongated shape connected to one pole of high voltage source of direct current, to whose opposite pole there is connected the collecting electrode arranged in the spinning chamber against the spinning electrode, while a section of circumference of the spinning electrode extends into a polymer solution in the reservoir while the reservoir of polymer solution is divided into the inlet section, into which leads at least one inlet opening, and into which the spinning electrode extends by a section of its circumference, and the outlet section, which is provided with outlet opening.

### TECHNICAL FIELD

Device for production of nanofibres through electrostatic spinning of polymer solutions comprising a spinning chamber, in which the reservoir of polymer solution is positioned, into which by a section of its circumference extends the rotating spinning electrode of elongated shape connected to one pole of high voltage source of direct current, to whose opposite pole there is connected the collecting electrode arranged in the spinning chamber against the spinning electrode, while a section of circumference of the spinning electrode extends into a polymer solution in the reservoir.

### BACKGROUND ART

Known device for production of nanofibres through electrostatic spinning of polymer solutions according to the CZ 294274 comprises a spinning chamber, in which there is arranged reservoir of polymer solution with opened level. In the reservoir of polymer solution there is rotatably mounted the spinning electrode of elongated shape, e.g. in a form of cylinder, which by a section of its circumference extends into a polymer solution in the reservoir and is connected to one pole of high voltage source of direct current. To the opposite pole of high voltage source of direct current there is connected the collecting electrode, arranged in the spinning chamber against the spinning electrode. By its rotation motion the spinning electrode on its surface carries out a certain quantity of polymer solution from the reservoir into a spinning space between the spinning electrode and the collecting electrode. Bottom of the reservoir has a cylindrical surface being parallel and running co-axially with longitudinal axis of the spinning electrode.

Due to the fact, that in most applications into a polymer solution either directly or through the spinning electrode a high voltage is brought, it is not possible to regulate or monitor the solution level in the reservoir by common electronic equipment and sensors. Quite frequently occurs, that the solution level in the reservoir is not kept on a constant height, which results in the fact that also immersion of the spinning electrode in a polymer solution is not constant, thus either too small or on the contrary too high quantity of polymer solution is carried out into the spinning space. In the first case, the capacity of device for electrostatic spinning is not used optimally, in the second case, on surface of the spinning electrode a film of polymer solution creates and solidifies, which has not undergone the spinning process in a spinning space, which results in gradual decreasing in efficiency of the device for electrostatic spinning.

Another disadvantage of the present state of the art is that thanks to relatively high viscosity of polymer solution, which is brought into the reservoir through an opening, performed mostly in the bottom of the reservoir, polymer solution does not disperse evenly and in time along a whole length of polymer reservoir, and so the level height is different along the length of reservoir and it may happen that while a section of the spinning electrode is overflown by polymer solution, the other section of the spinning electrode is not immersed at all in polymer solution. Moreover this is complicated by a fact, that due to effect of chemical and physical properties of polymer solution especially in remote places of the reservoir the areas with “used” polymer solution are created, where solidification of the level may occur.

The goal of the invention is to eliminate or at least to minimise the shortcomings of the present state of the art.

### THE PRINCIPLE OF INVENTION

The goal of the invention has been reached through a device for production of nanofibres through electrostatic spinning of polymer solutions according to the invention, whose principle consists in that, the reservoir of polymer solution is divided into an inlet section, into which leads at least one inlet opening for supply of polymer solution, and into which the spinning electrode extends by a section of its circumference, and the outlet section, which is provided with outlet opening for drainage of polymer solution.

According to the claim 2 between the inlet section and outlet section of reservoir there is performed a partition, which comprises an overflow of polymer solution, which determines level height in the inlet section of reservoir and ensures that its constant value is maintained, at the same time an excess polymer solution overflows thanks to an overflow from the inlet section of reservoir into the reservoir outlet section.

An overflow may be performed in several different ways—according to the claim 3 an overflow is performed by at least one opening in partition, in embodiment according to the claim 4 an overflow is formed by an upper edge of the partition, and according to advantageous embodiment in the claim 5 an overflow is performed by lowering the upper edge of the partition on borders of the partition.

In case that into the inlet section of the reservoir there lead several inlets of polymer solution, from the point of view of maintaining a constant level of polymer solution along the whole length of reservoir inlet section it is advantageous, if an overflow is formed not only by lowering the upper edge of the partition on its borders, but also by lowering the upper edge of partition between the neighbouring inlets.

An important factor, through which behaviour and movement of polymer solution after its bringing into the reservoir inlet section may be affected considerably, is shaping of the bottom, while according to the claim 7 the bottom of reservoir inlet section is sloping towards the inlet opening, thus enabling distribution of polymer solution along the whole length of reservoir inlet section.

With respect to the physical properties of commonly used polymer solutions, according to the claim 8 it is advantageous, if in the reservoir inlet section there is positioned at least one movable element, which through its movement initiates movement of polymer solution, with advantage in direction from the inlet opening to faces of the reservoir. Movement of this moveable element then not only results in a relatively even distribution of polymer solution along the whole length of reservoir inlet section, but it also prevents drying of polymer solution in the reservoir inlet section. Even better results are achieved, if according to the claim 9, at least a part of this moveable element extends above the level of polymer solution in the reservoir inlet section.

From the point of view of arrangement of the moveable element in the inlet section of reservoir it is advantageous, if this moveable element by its activity extends into the largest possible area of the reservoir inlet section, while according to the claim 10 this moveable element is a worm, whose longitudinal axis is parallel with rotation axis of the spinning electrode.

At a certain arrangement of the inlet opening (openings) it is further advantageous, if the screwline of at least a part of the worm is arranged contrary than the screwline of the rest part of the worm, through which it is achieved that the polymer solution upon rotation of a whole worm in one direction is being spread from inlet opening in direction towards both opposite faces of the reservoir.

In the same manner as bottom of the reservoir inlet section is shaped, according to the claim 12 also the bottom of the reservoir outlet section is shaped—it is sloping towards at least one outlet opening through which the polymer solution is drained from the reservoir, which contributes to movement of a used polymer solution from faces of reservoir to the outlet opening.

In an advantageous embodiment according to the claim 13 in the reservoir outlet section there is mounted at least one moveable element, which through its movement initiates a movement of polymer solution, which prevents its drying and supports its movement in the direction from faces of the reservoir towards the outlet opening, while at least a part of this moveable element according to the claim 14 extends above level of polymer solution.

In embodiment according to the claim 15 the moveable element in the reservoir outlet section is a worm.

According to the claim 16 it is advantageous if the screwline of at least a part of the worm is of a contrary arrangement than the screwline of remaining part of the worm, through which it is achieved, that upon worm rotation in one direction the polymer solution is delivered from the whole reservoir outlet section towards the outlet opening, through which it is further drained out of the polymer solution reservoir.

With respect to the fact that the polymer solution becomes dry on surface of the spinning electrode, according to the claim 17 on upper edge of partition there is arranged a comb serving in connection with rotation movement of the spinning electrode for removal of polymer solution from surface of the spinning electrode.

### DESCRIPTION OF THE DRAWING

In the enclosed drawing the FIG. 1 schematically represents a cross section of the spinning chamber of the device for electrostatic spinning; the

FIG. 2a schematically represents a longitudinal cross section of the reservoir inlet section of polymer solution; the

FIG. 2b schematically represents a longitudinal cross section of reservoir inlet section of polymer solution in an alternative embodiment; the

FIG. 3 schematically represents a longitudinal cross section of the reservoir inlet section of polymer solution in another alternative embodiment, and the

FIG. 4 schematically represents a cross section of the polymer solution reservoir of the device for production of nanofibres with alternative embodiment of the dividing partition.

### EXAMPLES OF EMBODIMENT

The device for production of nanofibres through electrostatic spinning of polymer solutions in electric field between at least one rotatably mounted spinning electrode of an elongated shape extending by a section of its circumference into the polymer solution in the polymer solution reservoir, and against it arranged collecting electrode according to the invention will be described in an example of embodiment represented schematically in the FIG. 1, where in the lower section of the spinning chamber 1 of the device for production of nanofibres through electrostatic spinning is arranged the reservoir 2 of polymer solution 21, in which the spinning electrode 3 of an elongated shape is mounted rotatably, which by a section of its surface extends into the polymer solution 21 contained in the reservoir 2. The spinning electrode 3 is in a known not represented manner connected with the not represented high voltage source of direct current and with not represented drive for its rotation movement.

In the upper section of the spinning chamber 1, in a space above the free surface of the spinning electrode 3, there is arranged the collecting electrode 4, whose shape is usually surface, as it is in the represented example of embodiment, or cylindrical. The collecting electrode 4 in a known not represented manner is connected with opposite pole of a not represented high voltage source of direct current. In some cases it is advantageous, if the spinning electrode 3 or the collecting electrode 4 is grounded.

In the space between the spinning electrode 3 and the collecting electrode 4, parallel with surface of the collecting electrode 4, there is performed a path for the substrate material 5, coupled by means of not represented known means for initiating of its movement e.g. in direction of the arrow A. The substrate material 5 in most cases is formed by a textile formation and it serves as a means for depositing of polymer nanofibres.

In reservoir 2 of polymer solution 21 parallel with the rotation axis of the spinning electrode 3 there is arranged a partition 6 formed by a planar wall, which divides the reservoir 3 along its whole length to the inlet section 7, into which the spinning electrode 3 extends, and the outlet section 8. The partition 6 is arranged on bottom of the reservoir 3 and its height is smaller than the depth of the reservoir 2. Furthermore the partition 6 is provided with an overflow, which serves for overflowing of polymer solution 21 from the inlet section 7 of reservoir 2 into the outlet section 8 of reservoir 2. An overflow is performed e.g. by lowering 60 of the upper edge of partition 6, by means of an opening in the partition 6 or directly by an upper edge of the partition 6.

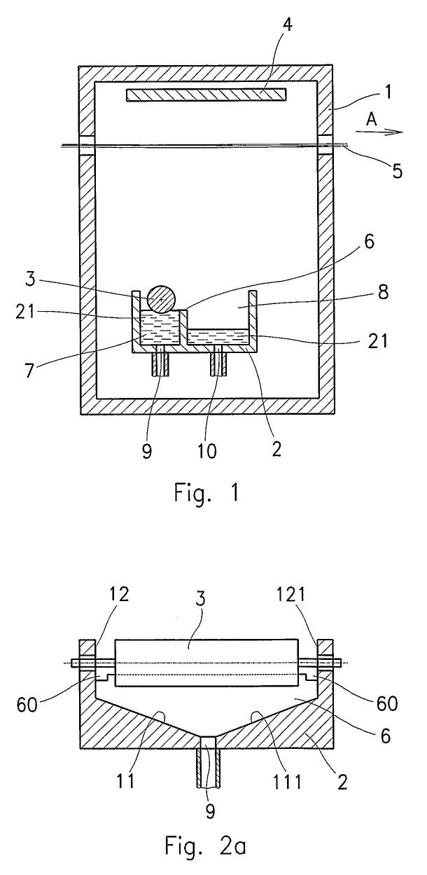

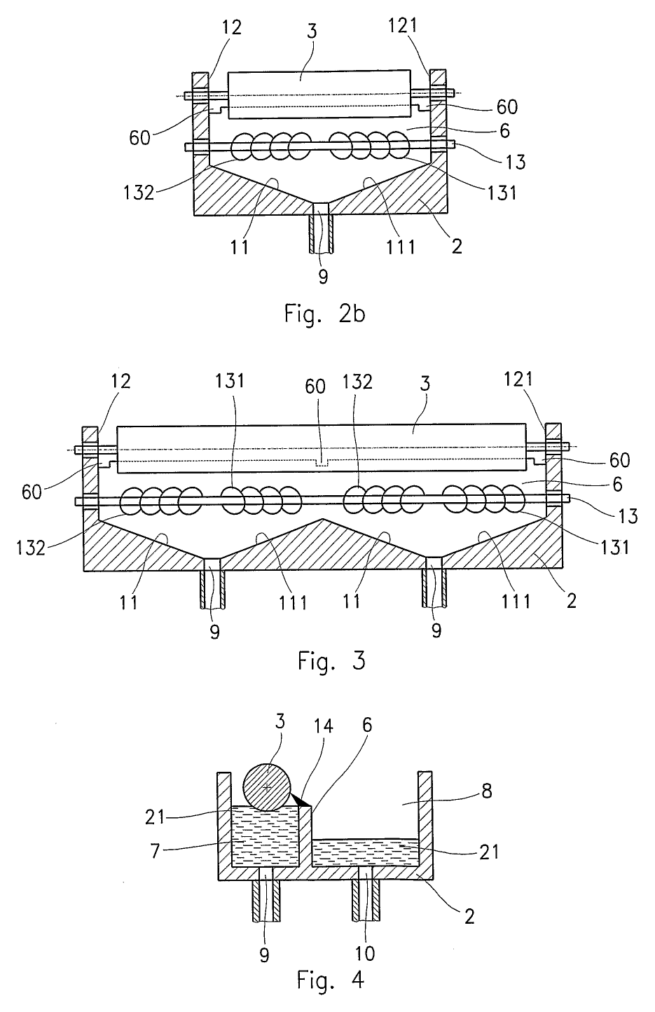

The FIG. 2a schematically represents a longitudinal cross section of one of possible variants of performance of the inlet section 7 of reservoir 2, when in the faces 12 and 121 of reservoir 2 there is rotatably mounted a shaft of the spinning electrode 3 with horizontal axis of rotation. From the faces 12 and 121 of reservoir 2 two symmetrical planes 11 and 111 are sloping which form the bottom of the inlet section 7. On intersection of symmetrical planes 11 and 111, i.e. in the lowest gradient place of bottom of the inlet section 7, there is then performed an inlet opening 9, serving for delivery of polymer solution 21 from the not represented source into the inlet section 7 of reservoir 2. In some cases of embodiment with respect to the properties of polymer solution 21 it is advantageous if the planes 11 and 111 are replaced by symmetrical convex, possibly concave surfaces.

The outlet section 8 of reservoir 2 by its structure is similar to the described inlet section 7, with the difference that the spinning electrode 3 does not extend into the outlet section 8. The bottom of the outlet section 8 is formed by two symmetrical planes 11 and 111, which are sloping to the outlet opening 10, which serves for drainage of polymer solution 21 from the outlet section 8 of reservoir 2. Symmetrical planes 11 and 111 in certain not represented examples of embodiment are replaced by symmetrical convex or concave surfaces.

The inlet section 7 and the outlet section 8 are mutually separated by a partition 6, whose integral part is an overflow of polymer solution 21, performed by lowering 60 of upper edge of the partition 6 on its borders.

Example of embodiment according to the invention represented in the FIG. 2b is intended first of all for usage in applications, when the length of the spinning electrode 3 thus the length of the inlet section 7 and outlet section 8 of reservoir 2 is considerably higher than in previous examples of embodiment. Under the spinning electrode 3, out of contact with it, in the faces 12 and 121 of the reservoir 2 there is rotatably mounted the worm 13, which is parallel with rotation axis of the spinning electrode 3. The worm 13 is formed by a couple of segments 131 and 132, which differ one from another especially by a opposite arrangement of the screwline. The whole worm 13 in a represented example of embodiment is positioned under the level of polymer solution 21 in the inlet section 7, nevertheless in some cases it is advantageous, if at least a part of the worm 13 extends above the level. Bottom of the inlet section 7 is performed, similarly as in the previous example of embodiment, by two symmetrical planes 11 and 111, which are sloping from the faces 12 and 121 of the reservoir 2, and on their intersection there is performed the inlet opening 9.

The outlet section 8 of reservoir 2 is then in one of examples of embodiment performed in the same way as the outlet section 8 described in the previous example of embodiment.

In another variant of embodiment the structure of the outlet section 8 of reservoir 2 is identical with structure of inlet section 7, with the difference that the spinning electrode 3 does not extend into the outlet section 8.

In one example of embodiment the worm 13 mounted in the inlet section 7 and the worm 13 mounted in the outlet section 8 are coupled with the common drive and arrangement of screwlines of segments 131 and 132 of worm 13 mounted in the outlet section 8 and of the worm 13 mounted in the inlet section 7 are contrary.

Also in this case the inlet section 7 and the outlet section 8 of the reservoir 2 are mutually separated by a partition 6, whose structure is identical with structure of the partition 6 described in the previous example of embodiment.

In the FIG. 3 there is schematically represented a longitudinal section of the inlet section 7 of reservoir 2 in alternative embodiment, which is made by arrangement of two inlet sections 7 represented in the FIG. 2b one behind another, in rotation axis of the spinning electrode 3, while inner spaces of the inlet sections 7 are inter-connected by removing the close adjoining faces 121 and 12 of these inlet sections 7. Along the whole length of the inlet section 7 represented in the FIG. 3 under the spinning electrode 3, parallel with its rotation axis, rotatably there is arranged the worm 13, formed by two couples of above described segments 131 and 132.

The outlet section 8 of reservoir 2 then by its structure corresponds to the described inlet section 7, but in another not represented examples of embodiment its structure corresponds to the structure of the outlet section 8 described in any from the above mentioned examples of embodiment.

The inlet section 7 from the outlet section 8 is divided by the partition 6, whose essential part is the overflow of polymer solution 21 performed by lowering 60 of upper edge of the partition 6 on its borders and between the neighbouring inlet openings 9.

In other not represented examples the inlet section 7 and the outlet section of reservoir 2 is performed identically as in the previous example of embodiment, but the worm 13 is not mounted in the inlet section 7 and/or in outlet section 8.

In another not represented examples of embodiment the inlet section 7 of reservoir 2 may be performed by composition of substantially unlimited number of inlet sections 7 of reservoir 2 in the FIG. 2a and/or in principle of unlimited number of inlet sections 7 of reservoir 2 in the FIG. 2b.

The FIG. 4 schematically represents an example of embodiment, where regardless the structure of the inlet section 7 and the outlet section 8 of reservoir 2, the upper edge of the partition 6 is shaped as a comb 14 to remove polymer solution 21 from surface of the spinning electrode 3.

In one not represented example of embodiment the inlet section 7 of reservoir 2 of polymer solution 21 is formed by an independent vessel, whose structure is close to some of the above described structures of the inlet section 7 of reservoir 2, and the outlet section 8 of reservoir 2 is formed by an independent vessel whose structure is close to some of the above described structures of the outlet section 8 of reservoir 2. Both vessels are then in some of the side walls provided with at least one opening, while by connecting of these openings the overflow of polymer solution 21 is performed between the inlet section 7 and outlet section 8 of reservoir 2. Connection of these openings is achieved by a mutual position of both vessels, possibly by their connection through a tubing, tray or hose, etc.

In the above described examples of embodiment of invention in the inlet section 7 and/or outlet section 8 of reservoir 2 the worm 13 is mounted parallel with the spinning electrode 3, nevertheless in other not represented examples of embodiment this worm 13 may be replaced by another moveable element positioned in the inlet section 7 and/or outlet section 8 of reservoir 2, which will execute the same, below described function. This moveable element may be e.g. an endless strip creating a section or the whole bottom of the inlet section 7 and/or of the outlet section 8, endless strip positioned in volume of the polymer solution 21, small propeller, system of small propellers etc., possible their combination.

After delivery of the polymer solution 21 from the chemical distribution system, which is in principle the source of polymer solution 21 through the inlet opening 9 into the inlet section 7 of reservoir 2 of polymer solution 21, in examples of embodiment, when in the inlet section 7 there is not positioned any moveable element, owing to shaping the bottom the polymer solution 21 is being spread along the whole length of the inlet section 7 of reservoir 2. The level of polymer solution 21 in the inlet section 7 increases and in the moment when it reaches the lowest point of upper edge of the partition 6, or an opening positioned in the partition 6, in this place the polymer solution 21 overflows from the inlet section 7 of reservoir 2 into the outlet section 8 of reservoir 2, through this it is reached that, in the inlet section of reservoir 2 the constant height of level of polymer solution 21 is maintained. Constant level of polymer solution 21 then causes, that also the depth of immersion of the spinning electrode 3 is constant in polymer solution 21, so that at the rotation movement of the spinning electrode 3, on its surface constantly there is carried out an optimum quantity of polymer solution 21 into the spinning space between the spinning electrode 3 and collecting electrode 4, where the polymer solution 21 is subject to spinning.

In example of embodiment, when in the inlet section 7 there is positioned the moveable element, the polymer solution 21 is being distributed along the whole length of the inlet section 7 of reservoir 2 not only due to shaping of bottom of the inlet section 7 of reservoir 2, but especially thanks to movement of this moveable element, e.g. the worm 13 mounted in the inlet section 7 of reservoir 2. Opposite arrangement of screwline of individual segments 131 and 132 of the worm 13 then at rotation of the whole worm 13 in one direction results in distribution of polymer solution 21, delivered by the inlet opening 9, in direction from inlet opening 9 to faces 12 and 121 to reservoir 2. Next to this, the rotation movement of the worm 13 causes movement of particles of polymer solution 21 in the inlet section 7 and/or outlet section 8 of reservoir 2, which leads to distinct restriction and in some examples even to elimination of solidification of level of polymer solution 21. This function in some cases is intensified also by that, the section of moveable element extends above the level of polymer solution 21.

In the moment when the level of polymer solution 21 in the inlet section 7 reaches the overflow, the polymer solution 21 overflows from the inlet section 7 of reservoir 2 into the outlet section 8 of reservoir 2, from where it is drained through the outlet opening 10. Into the outlet section 8 of reservoir 2, with advantage, also the polymer solution 21 is drained which by means of a comb 14 is being removed from surface of the spinning electrode 3.

In the outlet section 8 of reservoir 2 the polymer solution 21 by action of gravitation forces and in some examples also thanks to movement of moveable element, moves towards the outlet opening 10, through which it is drained from the reservoir 2 of polymer solution 21.

Examples of embodiment, when in the inlet section 7 and/or outlet section 8 of reservoir 2 there is arranged at least one moveable element, are usable especially at applications, when the density of polymer solution does not permit its sufficient movement, and when it is necessary to support or initiate its movement.

### List of Referential Markings

1 spinning chamber
2 polymer solution reservoir
21 polymer solution
3 spinning electrode
4 collecting electrode
5 substrate material
6 partition
60 lowering of the upper edge of partition
7 reservoir inlet section
8 reservoir outlet section
9 inlet opening
10 outlet opening
11 sloping plane
111 sloping plane
12 face of reservoir
121 face of reservoir
13 worm
131 worm segment
132 worm segment
14 comb

1. The device for production of nanofibres through electrostatic spinning of polymer solutions comprising a spinning chamber, in which the reservoir of polymer solution is positioned, into which by a section of its circumference extends the rotating spinning electrode of elongated shape connected to one pole of high voltage source of direct current, to whose opposite pole there is connected the collecting electrode arranged in the spinning chamber against the spinning electrode, while a section of circumference of the spinning electrode extends into a polymer solution in the reservoir, wherein the reservoir of polymer solution is divided into an inlet section, into which leads at least one inlet opening, and into which the spinning electrode extends by a section of its circumference, and the outlet section, which is provided with outlet opening.

2. The device as claimed in claim 1, wherein between the reservoir inlet section and the reservoir outlet section in the reservoir there is performed the partition, which is provided with an overflow.

3. The device as claimed in claim 2, wherein the overflow is performed by at least one opening in the partition.

4. The device as claimed in claim 2, wherein the overflow is formed by the upper edge of the partition.

5. The device as claimed in claim 2, wherein the overflow is performed by lowering the upper edge of the partition on its borders.

6. The device as claimed in claim 2, wherein the overflow is performed by lowering the upper edge of the partition between the neighbouring inlets of polymer solution.

7. The device as claimed in claim 1, wherein the inlet section of the reservoir has a bottom which is sloping towards at least one inlet opening of polymer solution.

8. The device as claimed in claim 1, wherein in the inlet section of the reservoir there is positioned at least one moveable element for initiating the movement of polymer solution.

9. The device as claimed in claim 8, wherein at least a section of moveable element extends above level of polymer solution.

10. The device as claimed in claim 8, wherein the moveable element is a worm.

11. The device as claimed in claim 10, wherein the screwline of at least a part of the worm is arranged contrary than the screwline of the rest part of the worm.

12. The device as claimed in claim 1, wherein the outlet section of the reservoir has a bottom which is sloping towards at least one outlet opening.

13. The device as claimed in claim 1, wherein in the outlet section of the reservoir there is positioned at least one moveable element to initiate the movement of polymer solution.

14. The device as claimed in claim 13, wherein at least a part of moveable element extends above the level of polymer solution.

15. The device as claimed in claim 13, wherein the moveable element is a worm.

16. The device as claimed in claim 15, wherein the screwline of at least a part of the worm is of a contrary arrangement than the screwline of remaining part of the worm.

17. The device as claimed in claim 1, wherein on the upper edge of the partition there is arranged the comb for removal of polymer solution from surface of the spinning electrode.
